(19) United States
(12) Patent Application Publication
(10) Pub. No.: US 2025/0302002 A1
(43) Pub. Date: Oct. 2, 2025

(54) FOLDABLE PET URINE ISOLATION PAD

(71) Applicant: Wellfine Silicone Products Co., Ltd., DONGGUAN (CN)

(72) Inventors: Feng LIU, DONGGUAN (CN); Shihao WANG, DONGGUAN (CN)

(21) Appl. No.: 18/954,936

(22) Filed: Nov. 21, 2024

(30) Foreign Application Priority Data
Mar. 27, 2024 (CN) 202420618725.6

(51) Int. Cl. A01K 1/01

(52) U.S. Cl. CPC A01K 1/0107

(57) ABSTRACT

The present disclosure relates to a foldable pet urine isolation pad including a first body, a second body and a middle body connected between the first and second bodies, wherein connection portions between the middle body and the first body, as well as the second body, can be bent along the middle body; a fixing portion formed on each of the first body, the second body and the middle body for installing diapers thereof. The improved pet urine isolation pad can be bent and used flexibly, which can better adapt to different usage scenarios. Each of the three bodies of the urine isolation pad has the fixing portions for installing a corresponding diaper thereon. When the urine isolation pad is laid flat or bent, it can effectively ensure that the diaper is attached and stably laid on the urine isolation pad.

### BACKGROUND

### 1. Technical Field

The present disclosure generally relates to the field of pet supplies, and especially relates to a pet urine isolation pad.

### 2. Description of Related Art

Nowadays, many families keep pets. In order to maintain better indoor hygiene, some pet owners train their pets to use a urine isolation pad that a diaper for pets is laid on the urine pad, so that excrement of pets falls on the diaper to be cleaned. A conventional urine isolation pad is a single flat plate that can only be used flat on the ground, in this way, sometimes the excrement of pets can be splashed onto a wall. Therefore, there is a room for improvement in terms of a conventional pet urine isolation pad.

### SUMMARY

The technical problems to be solved: in view of the shortcomings of the related art, the present disclosure provides an improved pet urine isolation pad, which can be bent to be adapted to more usage scenarios and better maintain indoor cleanliness.

The technical solution adopted for solving technical problems of the present disclosure is: a foldable pet urine isolation pad according to an embodiment of the present disclosure includes a first body, a second body, and a middle body connected between the first body and the second body, wherein connection portions between the middle body and the first body, as well as the second body, can be bent along the middle body; and wherein the first body includes a first fixing portion configured to install a diaper thereon, the second body including a second fixing portion configured to install a diaper thereon, and the third fixing portion including a third fixing portion configured to install a diaper thereon.

Wherein the first fixing portion includes at least one inserting hole passing through the urine isolation pad; the at least one inserting hole including a central hole position, and a plurality of wiring holes radiating outwards from the central hole position, a movable slice formed between adjacent wire holes.

Wherein the first fixing portion further includes two inserting holes with different sizes thereof.

Wherein the first body includes a pair of protrusions formed at both sides of an outer end thereof and being higher than a first top surface of the first body, the two inserting holes respectively formed on the air of protrusions.

Wherein the second fixing portion includes at least one through-hole configured to penetrate the diaper therethrough, a buckle arranged and inserted into the at least one through-hole for squeezing and restricting the diaper that is penetrated the at least one through-hole.

Wherein a sucker is arranged on a rear end of the buckle.

Wherein a magnet is arranged in the buckle, the urine isolation pad further including an independent magnetic metal sheet, and an adhesive layer arranged on the magnetic metal sheet.

Wherein the at least one through-hole and the buckle are respectively arranged on two sides of an outer end of the second body.

Wherein the third fixing portion includes an auxiliary buckle, the auxiliary buckle including a slot configured to insert the diaper thereof.

Wherein there are inserting grooves formed on both sides of a third top surface of the middle body, the auxiliary buckle installed into a corresponding inserting groove, and a rabbet of the slot of the auxiliary buckle is opened inwardly.

Wherein both a top surface and a bottom surface of the slot are provided with tooth patterns.

Wherein the urine isolation pad is square and made of a silicone material.

The present disclosure provides the advantages as below: the pet urine isolation pad has three bodies that can be bent along their respective connection positions between every two adjacent bodies. When the pet urine isolation pad is used, the pet urine isolation pad can be laid flat as a whole, or the first body is laid flat on the ground, and the second body is abutted against a wall; and then according specific usage needs, the middle body can be laid flat or abutted against the wall. The pet diapers can be stably laid on the urine isolation pad by a corresponding fixing portion of each of the three bodies, which can provide a multi directional protection and effectively prevent the excrement of pets from dirtying indoor environments.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. The same reference numerals in the accompanying drawings indicate the same or similar components or parts, one of ordinary skill in the related art should understand that these drawings are not necessarily drawn to scale.

FIG. 1 is a schematic view of a foldable pet urine isolation pad in accordance with an embodiment of the present disclosure, shown in the foldable pet urine isolation pad in a first state.

FIG. 2 is similar to FIG. 1, but shown the foldable pet urine isolation pad in a second state.

FIG. 3 is similar to FIG. 2, but shown the foldable pet urine isolation pad in a third state.

FIG. 4 is similar to FIG. 3, but shown the foldable pet urine isolation pad from another view.

FIG. 5 is a schematic view of a first fixing portion of the foldable pet urine isolation pad of FIG. 1.

FIG. 6 is a schematic view of a third fixing portion of the foldable pet urine isolation pad of FIG. 1.

FIG. 7 is a cross-sectional view of the third fixing portion of the foldable pet urine isolation pad of FIG. 1.

FIG. 8 is a cross-sectional view of a magnetic metal sheet of the foldable pet urine isolation pad of FIG. 1.

FIG. 9 is a schematic view of the magnetic metal sheet and an adhesive layer of the foldable pet urine isolation pad of FIG. 1.

The element labels according to the embodiment of the present disclosure shown as below:

A urine isolation pad, 1 first body, 111 first fixing portion, 10 inserting hole, 100 central hole position, 101 wiring hole, 102 movable slice, 11 protrusion, 12 first outer end side, 13 first top surface, 2 second body, 222 second fixing portion, 20 through-hole, 21 buckle 210 sucker, 211 rear end, 212 magnet, 213 magnetic metal sheet, 214 adhesive layer, 215 second outer end side, 3 middle body, 333 third fixing portion, 30 auxiliary buckle, 31 slot, 310 rabbet, 311 second top surface, 312 bottom surface, 313 tooth pattern, 32 third top surface, 33 inserting groove, 4 connection portion.

### DETAILED DESCRIPTION

In order to more clearly understand the technical solution hereinafter in embodiments of the present disclosure, reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples.

According to the described embodiment of the present disclosure, all other embodiments obtained by one of ordinary skill in the related art without the need for a creative labor are within the protection scope of the present disclosure. Unless defined otherwise, the technical terms or scientific terms used for the present disclosure shall be a general meaning commonly understood by those having ordinary skill in the related art to which the present disclosure is applied.

In the description of the present disclosure, it needs to be understood that the terms mentioned below: the terms such as “first” and “second” shown in the specification are only used to describe, but not indicated that the elements of the present disclosure is important or represented the amount of the elements. That is, the features limited by the terms of “first” and “second” may explicitly or implicitly include one or more features. Similar, in the description of the present disclosure, the meaning of the term “one”, “a” and “the” don't indicate a quantitative limit, but indicate that it includes at least one unless it is specifically illustrated. Furthermore, the terms such as “include”, “including”, “comprising” and “comprise” and the like means that elements or items in front of such term is intended to cover the elements or objects appeared the list behind the term and its equivalent, without excluding other elements or items. In the description of the present disclosure, except where specifically otherwise illustrated or limited, the terms “install”, “connect”, “link” and “fix” used herein should be understood in a broad perceive. Such as, the meaning may be tight connection, removable connection, or integrated connection. The meaning may also be mechanical connection, electrical connection, direct connection or indirect connection through intermediaries, or internal connection within two elements. The meaning of the terms used herein may be understood by one of ordinary skill in the related art according to specific conditions of the present disclosure. In addition, the terms such as “upper”, “below”, “left”, and “right”, etc, are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or elements of the present disclosure should have a particular orientation or should be designed and operated in a particular orientation. So the terms illustrated in the detail description are not by way of the limitation of the present disclosure.

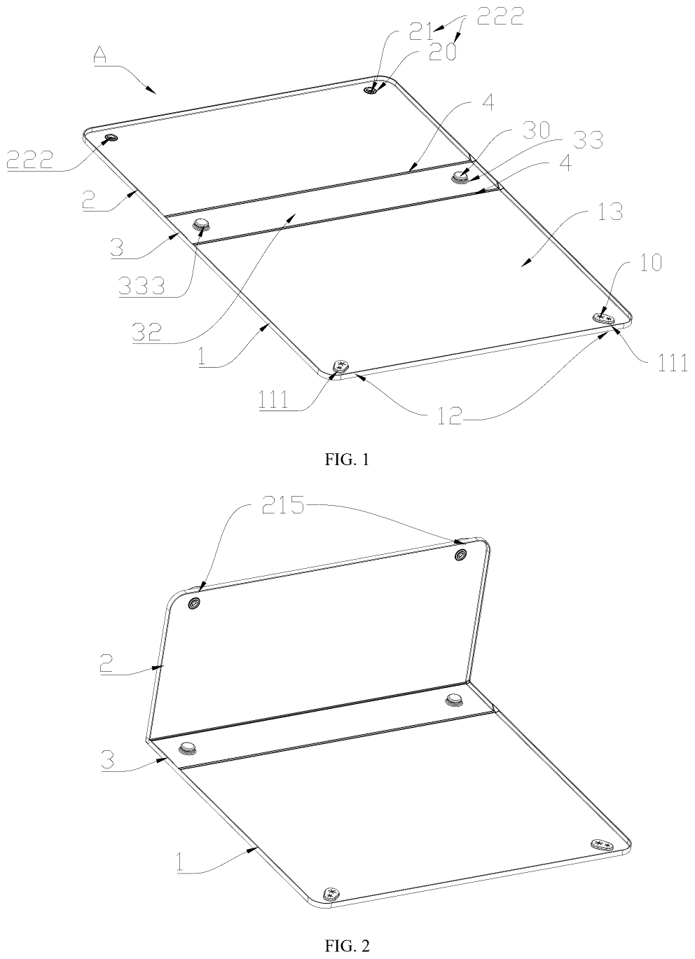

Referring to FIG. 1 to FIG. 4, a foldable pet urine isolation pad A according to an embodiment of the present disclosure includes a first body 1, a second body 2, and a middle body 3 connected between the first body 1 and the second body 2, wherein connection portions between the middle body 3 and the first body 1, as well as the second body 2, can be bent along the middle body 3; and wherein the first body 1 includes a first fixing portion 111 configured to install a diaper thereon, the second body 2 including a second fixing portion 222 configured to install a diaper thereon, and the third fixing portion 3 including a third fixing portion 333 configured to install a diaper thereon.

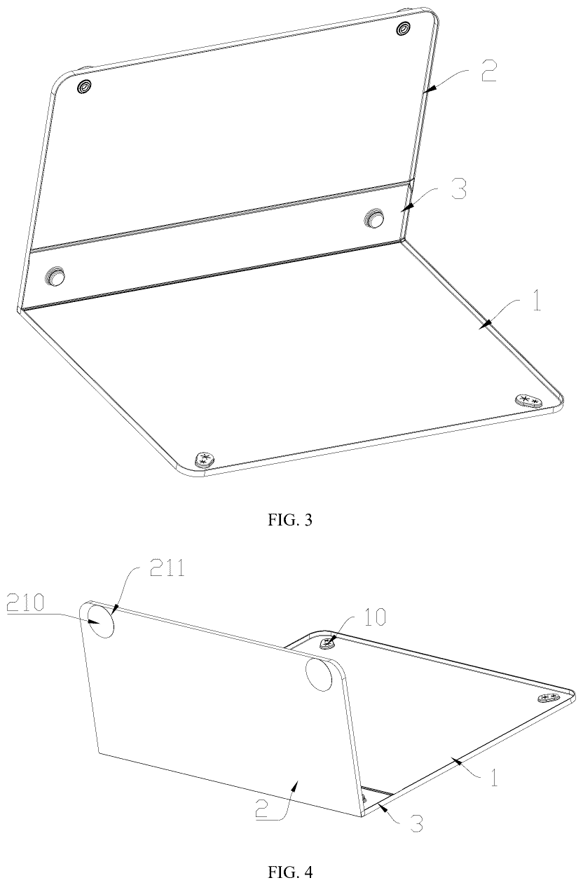

The urine isolation pad A is composed of three bodies connected in turn. The first body 1 and the second body 2 are connected on both sides of the middle body 3, and both the first body 1 and the second body 2 can be bent along a corresponding connection position 4 that is respectively connected with the middle body 3, thereby changing an overall state of the urine isolation pad A, as shown in FIG. 1, the urine isolation pad A is in an overall flat state; as shown in FIG. 2, the urine isolation pad A is bent along the connection position 4 that is connected between the second body 2 and the middle body 3, at this time, the second body 2 is in a longitudinal state and can be abutted against the wall, while both the first body 1 and the middle body 3 are laid flat on the ground; as shown in FIG. 3, the urine isolation pad A is bent along the connection position 4 that is connected between the middle body 3 and the first body 1, at this time, the first body 1 is laid flat on the ground, while both the second body 2 and the middle body 3 are abutted against the wall.

The diaper for pets is laid on a surface of the urine isolation pad A, and is stably connected by corresponding fixing portions of the first body 1, the second body 2, and the middle body 3, so that the diaper can be stably and firmly laid on the urine isolation pad A.

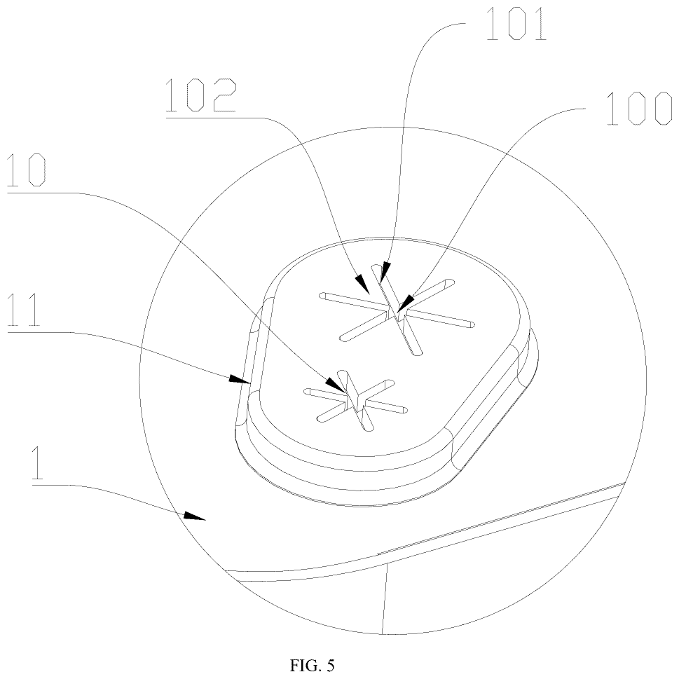

Referring to FIG. 5, the first fixing portion 111 includes at least one inserting hole 10 passing through the urine isolation pad A; the at least one inserting hole 10 including a central hole position 100, and a plurality of wiring holes 101 radiating outwards from the central hole position 100, a movable slice 102 formed between adjacent wire holes 101. As shown in FIG. 5, the at least one inserting hole 10 is in a shape of an “*”. When laying the diaper, top corners of the diaper are rolled thin to a rough rope shape, and then pass through the at least one inserting hole 10 from top to bottom. Especially the movable slice 102 will enhance resistance to the diaper to effectively prevent the diaper from being easily detached.

In some embodiments of the present disclosure, the first fixing portion 111 further includes two inserting holes 10 with different sizes thereof. Top corners of the diaper that are rubbed into a rope shape successively pass through the two inserting holes 10 with one large and one small, to strengthen a confinement effect of the diaper.

In some embodiments of the present disclosure, the first body 1 includes a pair of protrusions 11 formed at both sides 12 of an outer end thereof and being higher than a first top surface 13 of the first body 1, the two inserting holes 10 respectively formed on the air of protrusions 11. The excrement of pets may overflow from the diaper onto the bodies of the urine isolation pad A, The pair of protrusions 11 is provided to form an obstacle through a height difference thereof, which can effectively prevent the excrement from overflowing to the ground through the inserting hole 10.

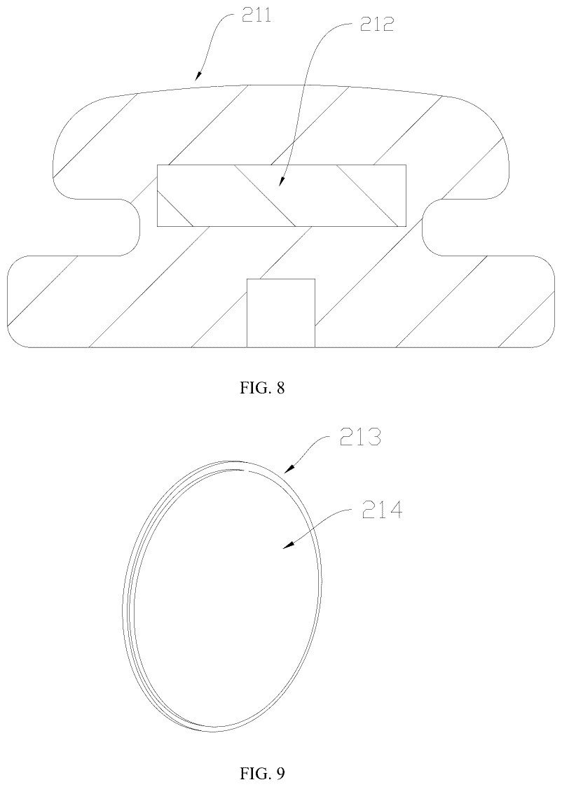

Referring to FIG. 4, the second fixing portion 222 includes at least one through-hole 20 configured to penetrate the diaper therethrough, a buckle 21 arranged and inserted into the at least one through-hole 20 for squeezing and restricting the diaper that is penetrated the at least one through-hole 20. The top corner of the diaper is twisted into a rope shape and squeezed into the through-hole 20, so that the diaper will not easily detach under a pressure of the buckle 21. Furthermore, a sucker 210 is arranged on a rear end 211 of the buckle 21. The second body 2 can be firmly connected to the wall through the sucker 210. The sucker is commonly used to adsorb the second body 2 to the wall, thereby ensuring that the second body 2 is in a stable upright state. The sucker 210 can be bonded or a vacuum adsorbed, etc. Alternatively, as shown in FIGS. 8-9, a magnet 212 is arranged in the buckle 21, the urine isolation pad A further including an independent magnetic metal sheet, 213 and an adhesive layer 214 arranged on the magnetic metal sheet 213. The magnetic metal sheet 213 is adhered to the wall or other positions through the adhesive layer 214, and the magnet 212 inside the buckle 21 is magnetically fixed to the magnetic metal sheet 213, thereby fixing the second body 2 to the wall or other positions.

Preferably, the at least one through-hole 20 and the buckle 21 are respectively arranged on two sides 215 of an outer end of the second body 2.

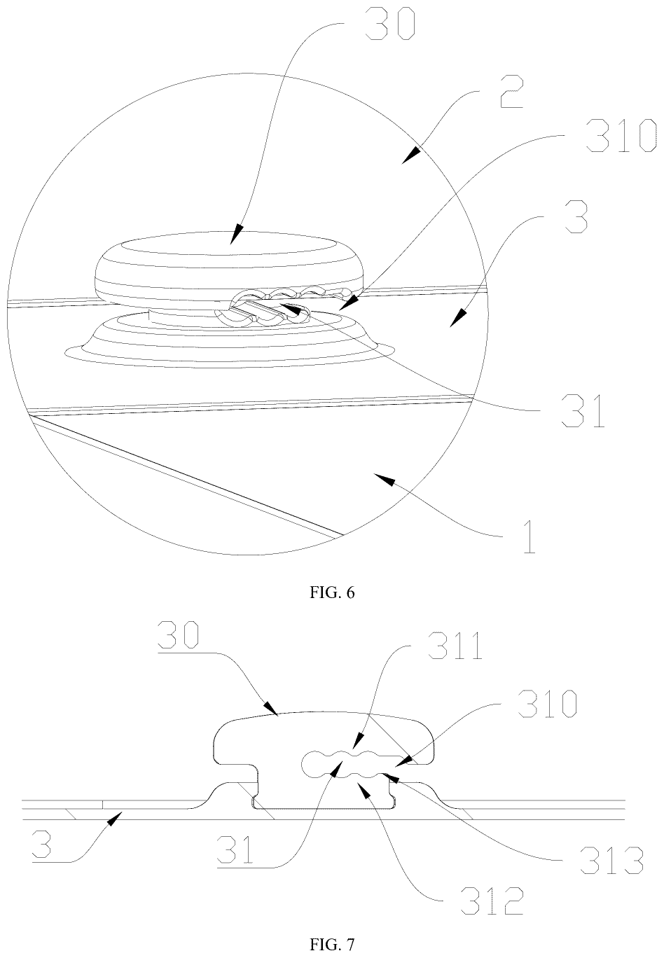

Referring to FIG. 6 and FIG. 7, in some embodiments of the present disclosure, the third fixing portion 333 includes an auxiliary buckle 30, the auxiliary buckle 30 including a slot 31 configured to insert the diaper thereof. Two ends of the diaper are fixed by the first fixing portion 111 and the second fixing portion 222 of the first body 1 and the second body 2, respectively, while a middle position of the diaper is stabilized by the auxiliary buckle 30. A middle edge of the diaper is inserted into the slot 31 of the auxiliary buckle 30, so that the diaper can be more firmly laid on the urine isolation pad A. Even if the urine isolation pad A bends along the connection position 4 that is connected between the middle body 3 and the first body 1 or the second body 2, the diaper will bend accordingly and will not protrude randomly.

Furthermore, there are inserting grooves 33 formed on both sides of a third top surface 32 of the middle body 3, the auxiliary buckle 30 installed into a corresponding inserting groove 33, and a rabbet 310 of the slot 31 of the auxiliary buckle 30 is opened inwardly. The auxiliary buckle 30 and the slot 33 can be strengthened to connect with each other by an adhesive bonding way. Each auxiliary buckle 30 can be installed near edges of both sides of the middle body 3, and the rabbet 310 of the slot 31 of each auxiliary buckle 30 faces inwardly (in the middle of the body). When the diaper is laid on the urine isolation pad A, edges of the diaper enter the slot 31 through the rabbet 310. Preferably, a second top surface 311 and a bottom surface 312 of the slot 31 are both provided with tooth patterns 313 to enhance the clamping and stabilizing effect of the diaper.

Generally, the urine isolation pad A is square and made of a silicone material. Both the buckle 21 and the auxiliary buckle 30 can also be made of silicone materials. When a square diaper is laid on the urine isolation pad A, two top corners of one end of the diaper are rubbed into a rope shape and then respectively pass through corresponding inserting holes 10 that are arranged on both sides of the outer end of the first body 1, while, two top corners of the other end of the diaper are clamped between the through-holes 20 and the buckles 21, and a middle side of the diaper enters the slot 31 through the rabbet 310. In this way, the overall diaper is relatively flat and obediently laid on the urine isolation pad A. Even though the urine isolation pad A is bent, the diaper is also followed the bending of the urine isolation pad A and is in an obedient state.

To sum up, the improved pet urine isolation pad of the present disclosure can be bent and used flexibly, which can better adapt to different usage scenarios. Each of the three bodies of the urine isolation pad has the fixing portions for installing a corresponding diaper thereon. When the urine isolation pad is laid flat or bent, it can effectively ensure that the diaper is attached and stably laid on the urine isolation pad.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A foldable pet urine isolation pad comprising:
a first body, a second body, and a middle body connected between the first body and the second body, wherein connection portions between the middle body and the first body, as well as the second body, can be bent along the middle body; and wherein
the first body comprises a first fixing portion configured to install a diaper thereon, the second body comprising a second fixing portion configured to install a diaper thereon, and the third fixing portion comprising a second fixing portion configured to install a diaper thereon.

2. The foldable pet urine isolation pad as claimed in claim 1, wherein the first fixing portion comprises at least one inserting hole passing through the urine isolation pad; the at least one inserting hole comprising a central hole position, and a plurality of wiring holes radiating outwards from the central hole position, a movable slice formed between adjacent wire holes.

3. The foldable pet urine isolation pad as claimed in claim 2, wherein the first fixing portion further comprises two inserting holes with different sizes thereof.

4. The foldable pet urine isolation pad as claimed in claim 3, wherein the first body comprises a pair of protrusions formed at both sides of an outer end thereof and being higher than a first top surface of the first body, the two inserting holes respectively formed on the air of protrusions.

5. The foldable pet urine isolation pad as claimed in claim 1, wherein the second fixing portion comprises at least one through-hole configured to penetrate the diaper therethrough, a buckle arranged and inserted into the at least one through-hole for squeezing and restricting the diaper that is penetrated the at least one through-hole.

6. The foldable pet urine isolation pad as claimed in claim 5, wherein a sucker is arranged on a rear end of the buckle.

7. The foldable pet urine isolation pad as claimed in claim 5, wherein a magnet is arranged in the buckle, the urine isolation pad further comprising an independent magnetic metal sheet, and an adhesive layer arranged on the magnetic metal sheet.

8. The foldable pet urine isolation pad as claimed in claim 5, wherein the at least one through-hole and the buckle are respectively arranged on two sides of an outer end of the second body.

9. The foldable pet urine isolation pad as claimed in claim 1, wherein the third fixing portion comprises an auxiliary buckle, the auxiliary buckle comprising a slot configured to insert the diaper thereof.

10. The foldable pet urine isolation pad as claimed in claim 9, wherein there are inserting grooves formed on both sides of a third top surface of the middle body, the auxiliary buckle installed into a corresponding inserting groove, and a rabbet of the slot of the auxiliary buckle is opened inwardly.

11. The foldable pet urine isolation pad as claimed in claim 10, wherein both a top surface and a bottom surface of the slot are provided with tooth patterns.

12. The foldable pet urine isolation pad as claimed in claim 1, wherein the urine isolation pad is square and made of a silicone material.
